(19) United States
(12) Patent Application Publication
(10) Pub. No.: US 2012/0292871 A1
(43) Pub. Date: Nov. 22, 2012

(54) ROLL STABILIZER OF A MOTOR VEHICLE

(75) Inventors: Bernd Wittmann, Pommersfelden (DE); Ralf Mayer, Herzogenaurach (DE); Jens Heim, Bergheinfeld (DE)

(73) Assignee: SCHAEFFLER TECHNOLOGIES AG & CO. KG, Herzogenaurach (DE)

(21) Appl. No.: 13/472,578

(22) Filed: May 16, 2012

(30) Foreign Application Priority Data
May 16, 2011 (DE) 102011075890.9

(51) Int. Cl. B60G 21/055

(52) U.S. Cl. 280/124.106

(57) ABSTRACT

A roll stabilizer of a motor vehicle including a back (1,9) and legs (3, 14, 15) arranged at opposite ends of the back (1, 9), at an angle in reference to the back (1,9) and with a suspension force (Fz) being transmitted into the ends of the legs facing away from the back (1, 9) to torsion the back (1, 9), and a force sensor (22) is provided to determine the suspension force (Fz).

### CROSS-REFERENCE TO RELATED APPLICATIONS

This application claims the benefit of German Patent Application No. 102011075890.9, filed May 16, 2011, which is incorporated herein by reference as if fully set forth.

### BACKGROUND

The invention relates to a roll stabilizer used in motor vehicles in order to improve road handling.

The pressure on a wheel at the outside of a curve and the unloading of the wheel at the inside of a cure create a torque in the roll stabilizer counteracting the rolling of the body when driving around a curve. For a simultaneous loading of the two wheels the stabilizer shows no effects. A one-sided loading when driving straight, for example when driving over uneven passages, may lead to movements of the vehicle about its longitudinal axis.

The roll stabilizer connects opposite wheels of an axis by a lever and a torsion spring. The resilience is achieved by the torsion of the torsion spring. The torsion spring may be formed by a torsion bar.

The center part of the roll stabilizer, called the back, is mounted rotationally at the body, and the angled legs acting as levers are directly or indirectly mounted to the wheel suspension elements, for example transverse links.

The back is stressed by torque. The back can be formed by a torsion bar, with the two ends facing away from each other being fastened to the two legs.

In active roll stabilizers the back may be formed by two stabilizer halves, perhaps formed by a divided torsion bar. A so-called actuator is arranged between ends of the parts of the torsion bar facing each other, actively causing a torque of the two parts of the torsion bar in reference to each other.

In passive roll stabilizers any different dipping behavior of the wheels of a lateral axis of a vehicle are compensated by torsion of the back of the roll stabilizer. The torsion section in passive roll stabilizers may extend over a large portion of the entire width of the vehicle.

The legs each form a lever engaging the torsion bar, with torque acting in the back via the effective lever arm of the leg, applying a supporting force upon the ends of the legs. The end of the leg represents the point of application for the supporting force, with a lever being formed between the point of application and the back to apply a torque.

The ends of the legs are supported at the wheel suspension elements. The supporting force can be transferred to the wheel suspension element and counteract an undesired dipping of the wheel at the outside of the curve.

In active roll stabilizers an actuator enhances the effective torque counteracting the rolling. Two stabilizer halves can be rotationally connected to each other via the actuator. Each stabilizer half may be embodied as a torsion bar. Both stabilizer halves may be provided at their ends facing away from each other with the respective legs in the above-described manner. The two stabilizer halves may be embodied of equal length, but also in different lengths. The actuator usually comprises a motor and a transmission connected thereto, with a torque created by the actuator being transferred between the two stabilizer halves.

The torque acting via the actuator between the two legs can be adjusted in a targeted fashion. The ends of the legs are connected to the wheel suspension elements, for example to a guide or a spring leg, and here transfer the supporting force.

The publication DE 102 33 499 A1 discloses a divided, active roll stabilizer with two stabilizer halves and with an actuator to control rolling, with the actuator comprising a device to transmit torque and a device to generate torque, with at least the device to generate torque being arranged outside the space between the two stabilizer halves.

In modern motor vehicles frequently active adjustment devices are used to improve driving safety, with their control devices processing parameters, such as lateral acceleration or the incline of the vehicle chassis about the longitudinal axis of the motor vehicle. In active roll stabilizers frequently the torque is detected acting in the back of the stabilizer. In case of passive roll stabilizers the measured torque provides information concerning the real-time condition of the axes; the control systems used can consider this information in order to perhaps prevent the vehicle from drifting. For large deflections of the wheels it may occur, however, that the actual torque cannot allow an unambiguous conclusion about the actual stress on the wheels.

### SUMMARY

The objective of the invention was to provide an improved roll stabilizer.

This objective has been attained in the roll stabilizer according to the invention. Due to the fact that a force sensor is provided to determine the suspension force, this suspension force acting at the wheel suspension element can be measured directly. Deformations of other stressed parts are irrelevant, here. In conventional torque measurements, based on the elastic deformation of loaded parts, insufficient correlation between actual suspension force and measured torque may be given. The invention avoids this disadvantage. Through use of the acting levers the torque acting in the roll stabilizer can be stated by the suspension force determined.

A force is directly measured by a force sensor or indirectly via a deformation of said force sensor; the force sensor may be arranged in the power train or parallel to the power train.

For the present invention, so-called spring bellows force sensors are suitable. Based on the force acting on the spring bellow, the force sensor is elastically deformed. The force compensation must occur in the pre-described direction. The deformation of the spring bellows is transferred via the strain gauges, with their electric resistance changing by the extension, into a change of an electric voltage. The electric voltage and thus the change of extension can be registered via the measuring amplifier. It can be converted into a force measurement based on the elastic features of the spring bellow, in which the force sensor is calibrated.

So-called membrane force sensors are suitable for the present invention. A cup-shaped metallic body is compressed and thus also the strain gauges applied distributed on its wall.

So-called Piezo-force sensors are suitable for the present invention. In a Piezo-ceramic element a charge distribution develops by the impact of force, which is proportional to the force. Each charge can be measured via a charge amplifier. Pressure or shearing forces can be measured depending on the type of the crystalline design of the Piezo-element. Tensile forces can only be measured with pre-stressing. Piezo-electric force sensor may be designed very stiffly and can also measure highly-dynamic forces.

The invention is particularly suitable for so-called pendulum-linked anti-roll bars. In a pendulum-linked anti-roll bar a pendulum assembly is supported at both ends in an articulate fashion, on the one side at the leg of the roll stabilizer, on the other side at a wheel suspension element. The pendulum assembly may be formed by a pendulum rod, which at both sides is supported via ball joints or rotary joints. Forces are transferred along an effective axis, with the bearing axles of both joints being located thereon. In a pendulum rod with a straight embodiment the effective axis and the axis of the pendulum rod may be coinciding.

Any transfer of lateral forces can be avoided by the articulate bearing of the pendulum rod. In case lateral forces being transferred, force sensors may be used which are insensitive for lateral forces.

The force sensor can be mounted directly at the pendulum assembly, with the pendulum assembly, due to a pressure or tensile force acting as a suspension force, can be elastically deformed when the vehicle chassis sways. Using the elastic deformation of the pendulum rod measured, the suspension force can be determined via the force sensor. In this case the force sensor is connected parallel in reference to the pendulum assembly.

In the pendulum stabilizer the suspension force is the force guided through the pendulum rod, transferred between the wheel suspension element and the leg of the roll stabilizer. When the suspension force is aligned perpendicular in reference to a plane containing the torsion axis, the active torque can be determined via the lever given by the distance of the torsion axis from said suspension force. When this suspension force is arranged perpendicular in reference to the leg, the length of the leg may simultaneously represent the effective lever. In this case the leg is located in a virtual plane, which also comprises the torsion axis. When the suspension force is not aligned perpendicularly but inclined in reference to the plane including the torsion axis via a common decomposition of force the portion of suspension force can be determined acting via the above-mentioned lever of the torque upon the back.

The pendulum assembly or the pendulum rod may be suspended via a connection element to the leg of the roll stabilizer and/or at a wheel suspension element. In this case, the force sensor may be arranged in said connection element. A force sensor arranged effectively at the connection element can directly measure the suspension force applied.

The connection element may be embodied as a ball joint or as a rotary joint. In this case, the force sensor may be connected serially with the pendulum rod, so that the suspension force is transferred entirely to the force sensor.

### BRIEF DESCRIPTION OF THE DRAWINGS

In the following the invention is explained in greater detail based on two exemplary embodiments shown in four figures. Shown are:

FIG. 1 is a view of an active pendulum stabilizer according to the invention in a schematic illustration,

FIG. 2 is a detail taken from FIG. 1 shown enlarged,

FIG. 3 is a schematic view of a passive pendulum stabilizer according to the invention in a schematic illustration, and

FIG. 4 is a view of a front-leg axis in a conventional pendulum stabilizer of prior art.

### DETAILED DESCRIPTION OF THE PREFERRED EMBODIMENTS

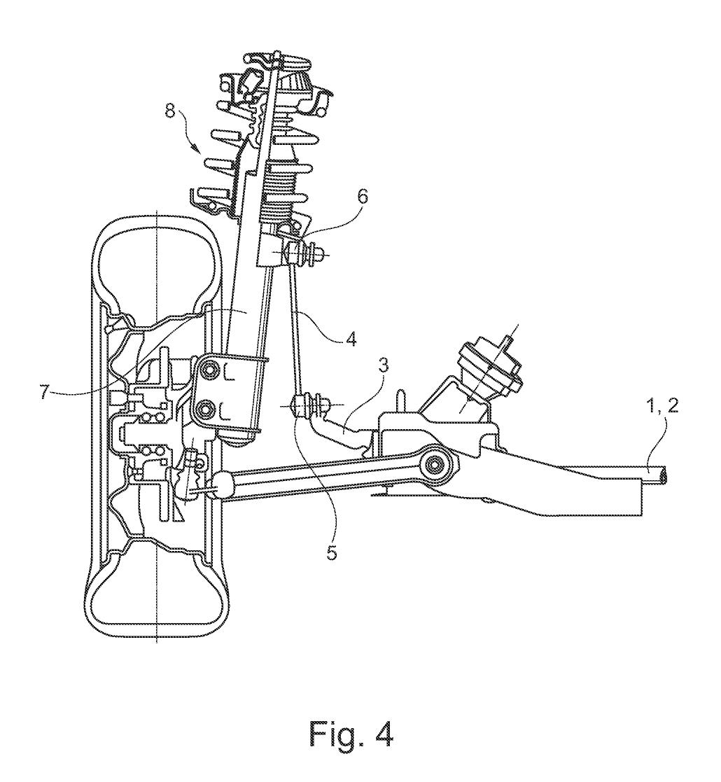

FIG. 4 shows a detail of a spring-leg frontal axis of prior art with a pendulum stabilizer as shown in the professional publication Jornsen Reimpell, “Fahrwerkstechnik: Grundlagen (Principles of suspension technology)”, Vogel Verlag, 3^{rd} issue on page 20. The pendulum stabilizer comprises a back 1, formed by a torsion bar 2. The torsion bar 2 is supported rotational about its axis at the vehicle chassis via a bearing, not shown. The torsion bar 2 extends perpendicularly in reference to the longitudinal axis of the vehicle. Legs 3 are connected in a torque-proof fashion at the two ends of the torsion bars 2, facing away from each other and at an angle in reference to the torsion bar 2.

FIG. 4 shows that a pendulum rod 4 is connected to the free end of the leg 3. The pendulum rod 4 is supported at one end via a lower ball joint 5 to the free end of the leg 3. The pendulum rod 4 is supported at its other end via an upper ball joint 6 to an exterior rod 7 of a spring leg 8.

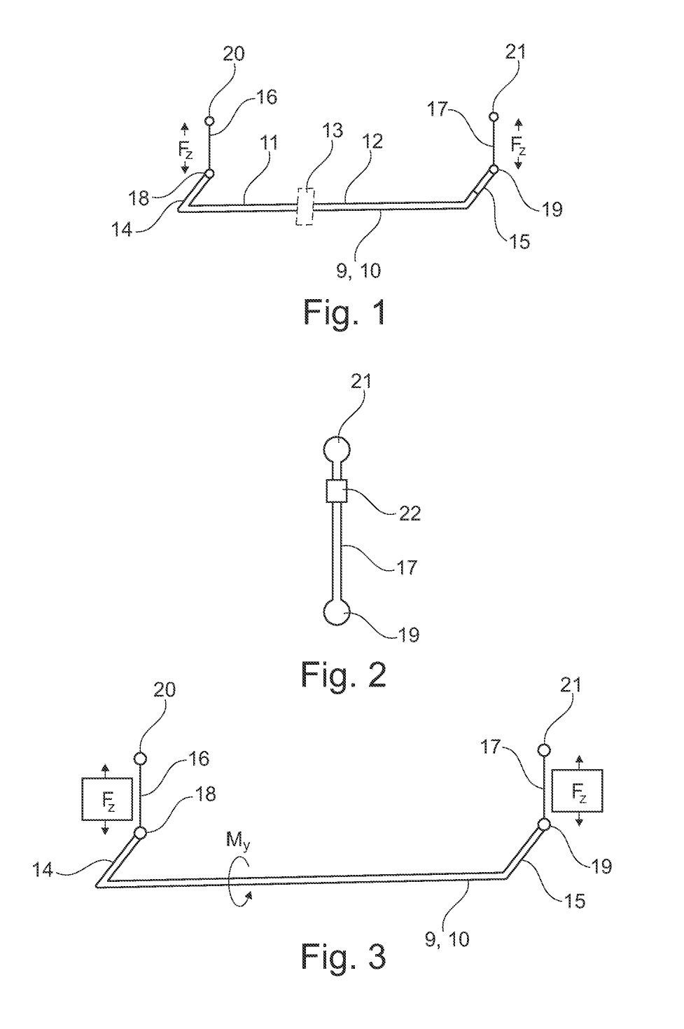

FIG. 1 shows in a schematic illustration an active roll stabilizer according to the invention. The pendulum stabilizer has a back 9, which is formed by a divided torsion bar 10. The torsion bar 10 can be subjected to torque. The torsion bar 10 is supported via a bearing, not shown, at the vehicle chassis, not shown, in a manner rotational about its longitudinal axis. The torsion bar 10 extends perpendicular in reference to the longitudinal axis of the vehicle.

An actuator 13 is arranged between the ends of the two torsion bar parts 11, 12 of the torsion bar 10 facing each other, connected to the two torsion bar parts 11, 12. By activating the actuator 13 the two stabilizer parts 11, 12 are rotated in reference to each other.

Legs 14, 15 are connected to the two ends of the two torsion bar parts 11, 12 of the torsion bar 10, facing away from each other, angled in reference to the torsion bar 2. In the illustration the legs 14, 15 are arranged at a right-angle in reference to the torsion bar 10.

One pendulum rod 16, 17 each is connected to the free ends of the legs 14, 15. Both pendulum rods 16, 17 are each supported at one end via a lower ball joint 18, 19 at the free end of the leg 14, 15. The pendulum rods 16, 17 are each supported at their other end via an upper ball joint 20, 21 to a wheel suspension element, not shown.

The pendulum rod 17 transfers a suspension force Fz between the wheel suspension element, not shown, and the leg 15. In the schematic illustration the axis of the pendulum rod and the effective axis of the suspension force Fz coincide. The pendulum rods 16, 17 are aligned perpendicularly in reference to a plane with a torsion axis of the torsion bar 10 extending through it. The two legs 14, 15 are located in this plane.

If the pendulum rod 16, 17 due to design requirements is not arranged perpendicular in reference to the plane including the torsion axis of the torsion bar 10 as well as the legs 14, 15 the suspension force can be decomposed into force components with one of them being arranged perpendicular in reference to this plane; this way, using the force component determined in this manner the effective torque in the torsion bar 10 can be determined.

FIG. 2 shows the pendulum rod 17 in an enlarged illustration. A force sensor 22 is mounted at the pendulum rod 17. By the suspension force Fz, determined via the force sensor 22, using the effective lever arm, the torque may be determined acting in the torsion bar 10. In the illustration according to FIG. 1 the effective lever arm is determined by the length of the legs 14, 15. The detection of the pendulum suspension force provides a signal proportional in reference to the torque acting in the torsion bar spring 10.

The force sensor 22 shown in FIG. 2 is an example for various types of force sensors. The force sensor 22 may be arranged in the power train or parallel to said power train. In the first alternative the support force Fz is guided through the pendulum rod 17 and through the force sensor 22. In the second alternative the suspension force Fz is only guided through the pendulum rod 17. Any elastic deformation of the pendulum rod 17 caused by the suspension force Fz is detected by the force sensor 22 and converted into a corresponding suspension force Fz. The force sensor 22 can be arranged in another variant in one of the ball joints 19, 21.

The force sensor 22 can also be inserted into the pendulum stabilizer of prior art, shown in FIG. 4, in the manner according to the invention.

The force sensor may be formed by an elastically deformed part, for example by a membrane or a bar. The suspension force is preferably guided through this elastically deformed part, which beneficially is designed such that lateral forces cannot lead to any considerable change of the measuring signal. The signal conversion occurs for example via resistance elements, as perhaps shown by strain gauges adhered thereto. The signal conversion can also occur magnetically or optically by distance measurement or by position measurement. Magneto-strictive or magneto-elastic force sensors may be used, here.

FIG. 3 shows another passive roll stabilizer according to the invention only differing from the roll stabilizer shown in FIGS. 1 and 2 such that the actuator is omitted, with here the torsion bar 10 not being divided.

### LIST OF REFERENCE CHARACTERS

1. back
2. torsion bar
3. leg
4. pendulum rod
5. lower ball joint
6. upper ball joint
7. external tube
8. spring leg
9. back
10. torsion bar
11. part of torsion bar
12. part of torsion bar
13. actuator
14. leg
15. leg
16. pendulum rod
17. pendulum rod
18. lower ball joint
19. upper ball joint
20. lower ball joint
21. upper ball joint

1. A roll stabilizer of a motor vehicle comprising a back (1, 9) and legs (3, 14, 15) arranged at opposite ends of the back (1, 9), angled in reference to the back (1, 9) and with a suspension force (Fz) adapted to be transmitted to ends of the legs (1, 9) facing away from the back (1, 9) to torsion the back (1, 9), wherein a force sensor (22) is provided to determine the suspension force (Fz).

2. The stabilizer according to claim 1, wherein a pendulum rod (4, 16, 17) is supported in an articulate fashion at each of the ends of the legs, with the suspension force (Fz) being guided through the pendulum rod (4, 16, 17).

3. The pendulum stabilizer according to claim 2, wherein the force sensor (22) is arranged at the pendulum rod (4, 16, 17).

4. The pendulum stabilizer according to claim 2, wherein the pendulum rod (4, 16, 17) is supported via a connection element at the leg (3, 14, 15) of the stabilizer with the force sensor (22) being arranged at the connection element.

5. The pendulum stabilizer according to claim 2, wherein the pendulum rod (4, 16, 17) is supported via a ball joint (5, 6, 18, 19, 20, 21), with the force sensor being arranged at the ball joint (5, 6, 18, 19, 20, 21).

6. The pendulum stabilizer according to claim 2, wherein the force sensor (22) is connected parallel to the pendulum rod (4, 16, 17) with an elastic deformation of the pendulum rod (4, 16, 17) developing under the suspension force (Fz) being detected by the force sensor (22).

7. The pendulum stabilizer according to claim 2, wherein the force sensor (22) is connected serially in reference to the pendulum rod (4, 16, 17), with the force sensor (22) supporting the suspension force (Fz).

8. The stabilizer according to claim 1, in which the force sensor (22) is embodied as a spring bellows—force sensor.

9. The stabilizer according to claim 1, in which the force sensor (22) is embodied as a membrane force sensor.

10. The stabilizer according to claim 1, in which the force sensor (22) is embodied as a Piezo-force sensor.
